(19) United States
(12) Patent Application Publication
(10) Pub. No.: US 2020/0250706 A1
(43) Pub. Date: Aug. 6, 2020

(54) INTELLIGENT ADVERTISEMENT IDENTIFICATION AND INTERACTION IN AN INTERNET OF THINGS COMPUTING ENVIRONMENT

(71) Applicant: INTERNATIONAL BUSINESS MACHINES CORPORATION, Armonk, NY (US)

(72) Inventor: Albert AVETISIAN, Bayside, NY (US)

(73) Assignee: INTERNATIONAL BUSINESS MACHINES CORPORATION, Armonk, NY (US)

(21) Appl. No.: 16/267,786

(22) Filed: Feb. 5, 2019

(51) Int. Cl. G06Q 30/02; G06K 19/06

(52) U.S. Cl. CPC G06Q 30/0265; G06K 19/06037; G06K 19/06028

(57) ABSTRACT

Embodiments for intelligent advertisement identification and interaction in an Internet of Things (“IoT”) computing environment by a processor. One or more indicators associated on an advertisement display may be captured using one or more IoT computing devices associated with a vehicle. A user may be prompted to interact with an advertisement associated with the one or more indicators. The advertisement, analytics associated with the advertisement, or a combination thereof may be displays on the one or more IoT computing devices upon acceptance of the advertisement.

### BACKGROUND OF THE INVENTION

### Field of the Invention

The present invention relates in general to computing systems, and more particularly, to various embodiments for intelligent advertisement identification and interaction in a vehicle in an Internet of Things (“IoT”) computing environment by a processor.

### Description of the Related Art

In today's society, consumers, business persons, educators, and others use various computing network systems with increasing frequency in a variety of settings. The advent of computers and networking technologies have made possible the increase in the quality of life while enhancing day-to-day activities. Computing systems can include an Internet of Things (IoT), which is the interconnection of computing devices scattered across the globe using the existing Internet infrastructure. IoT devices may be embedded in a variety of physical devices or products. As great strides and advances in technologies come to fruition, these technological advances can be then brought to bear in everyday life. For example, the vast amount of available data made possible by computing and networking technologies may then assist in improvements to quality of life.

### SUMMARY OF THE INVENTION

Various embodiments for intelligent advertisement identification and interaction in an Internet of Things (“IoT”) computing environment by a processor are provided. In one embodiment, by way of example only, a method for intelligent advertisement identification and interaction in an Internet of Things (“IoT”) computing environment by a processor is provided. One or more indicators associated on an advertisement display may be captured using one or more IoT computing devices associated with a vehicle. A user may be prompted to interact with an advertisement associated with the one or more indicators. The advertisement, analytics associated with the advertisement, or a combination thereof may be displays on the one or more IoT computing devices upon acceptance of the advertisement.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a diagram depicting various user hardware and computing components functioning in accordance with aspects of the present invention;

FIG. 5 is a block diagram depicting intelligent advertisement identification and interaction in an Internet of Things (“IoT”) computing environment according to an embodiment of the present invention;

FIG. 6 is a flowchart diagram of an exemplary method for implementing intelligent advertisement identification and interaction in an Internet of Things (“IoT”) computing environment by a processor, in which various aspects of the present invention may be realized; and

FIG. 7 is a flowchart diagram of an exemplary method for implementing intelligent advertisement identification and interaction in an Internet of Things (“IoT”) computing environment by a processor, in which various aspects of the present invention may be realized.

### DETAILED DESCRIPTION OF THE DRAWINGS

Computing systems may include large scale computing called “cloud computing,” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

Additionally, the Internet of Things (IoT) is an emerging concept of computing devices that may be embedded in objects, especially appliances, and connected through a network. An IoT network may include one or more IoT devices or “smart devices”, which are physical objects such as appliances with computing devices embedded therein. Many of these objects are devices that are independently operable, but they may also be paired with a control system or alternatively, a distributed control system such as one running over a cloud computing environment.

The prolific increase in use of IoT appliances in computing systems, particularly within the cloud computing environment, in a variety of settings provide various beneficial uses to a user. Various IoT appliances may be used for personal or commercial purposes. For example, as “in-vehicle” technology evolves, the effectiveness of classical outdoor advertisements (e.g., billboards/e-signs/video walls, LCD screens, posters, etc.) will decrease significantly. Similarly, these types of media/advertisements fail to include any elements of interactivity or personalization, further hindering their effectiveness. Thus, a need exists for a more useful, intricate, and ultimately effective advertisements to communicate to potential customers.

Accordingly, various embodiments are provided for a cognitive system included in a vehicle that is enhanced with imaging capabilities (e.g., ‘vision’, embedded cameras) that may search and scan surroundings for any type of media that contains machine-readable indicators. For example, such indicators may include, but are not limited to, quick response (QR) code, barcodes, one or more patterns, and/or other types of identifiable/scannable indicators. In one aspect, the cognitive system identifies surrounding media and prompts the vehicle (e.g., driver of the vehicle) with the ability to launch more details about the detected indicators/media such as, for example, a vehicle driving past a billboard advertisement and capturing an indicator displayed on the billboard advertisement. The vehicle is enabled to observe and capture the advertisement and scan a machine-readable signal. The driver may be directly prompted on a graphical user interface (“GUI”)/native screens of a vehicle (e.g., entertainment system, heads up display “HUD”, center console, etc.) for a user/driver to interact with the displayed prompt. In one aspect, the prompt may include, but not limited to, an internet/web page, a video, or some other form of interactive exchange.

In an additional aspect, the present invention provides for a cognitive system the provides an intelligent advertisement identification and interaction in an IoT computing environment by a processor is provided. One or more indicators associated on an advertisement display may be captured using one or more IoT computing devices associated with a vehicle. A user may be prompted to interact with an advertisement associated with the one or more indicators. The advertisement, analytics associated with the advertisement, or a combination thereof may be displays on the one or more IoT computing devices upon acceptance of the advertisement.

For example, consider the following use cases. In one use case, an interactive advertisement may be created in a vehicle based on a billboard. That is, a vehicle, equipped with one or more cameras, may be moving/driving on a road. The vehicle passes by an advertisement display (e.g., a billboard sign) that includes/displays a QR code. The vehicle's entertainment system prompts the driver to launch more details of the advertisement relating to the indicator.

In an additional use case, specific traffic information may be transmitted to a vehicle/driver under one or more defined/special conditions (e.g., detours). A vehicle equipped with cameras may be moving/driving on a road and a nearby bridge, for example, may be closed and a government/municipality has signified a detour. The government/municipality may include/adds a detour sign with a QR code to be displayed via an advertisement display. As the vehicle approaches the advertisement display, the vehicle may alert the driver that the recognized media is by a government/municipality authority and opens the specific details.

Thus, the present invention enables advertisers to target advertisements to drivers using personas based on personal information. The present invention may leverage existing infrastructure (e.g., billboards, posters, traffic signs) by elevating the functionality using one or more types technologies appearing on new vehicles.

In one aspect, the present invention provides for a cognitive system that connects with a vehicle that has enhanced imaging capabilities (e.g., camera). The vehicle, while in motion for example, may approach an advertisement display (e.g., a billboard, screen, sign, etc.) and capture any form of media with a machine-readable indicator. The vehicle may scan and/or capture the machine-readable indicator and send a signal to the cognitive system associated with the vehicle. The cognitive system may identify the content associated with the indicator. The cognitive system may send/push content and also a prompt to the vehicles' native screen (e.g., entertainment system, center console, etc.). The cognitive system may push associated analytics (e.g., location, identified media element, time, etc.) to other first and/or third-party systems. A driver of the vehicle may interact with a screen to view the additional content (e.g., accept the prompt), or dismiss the content (e.g., reject the prompt). If the cognitive system identified that the media was created by a government or municipal authority, the default action may be to automatically accept the prompt and display the additional information.

It should be noted as described herein, the term “cognitive” (or “cognition”) may be relating to, being, or involving intellectual activity such as, for example, thinking, reasoning, or remembering, that may be performed using machine learning or other techniques of artificial intelligence. In an additional aspect, cognitive or “cognition” may be the mental process of knowing, including aspects such as awareness, perception, reasoning and judgment. A machine learning system may use artificial reasoning to interpret data from one or more data sources (e.g., sensor-based devices or other computing systems) and learn topics, concepts, and/or processes that may be determined and/or derived by machine learning.

In an additional aspect, the terms “cognitive” or “cognition” may refer to a mental action or process of acquiring knowledge and understanding through thought, experience, and one or more senses using machine learning (which may include using sensor-based devices or other computing systems that include audio or video devices in lieu of human senses). The word “cognitive” may also refer to identifying patterns of behavior, leading to a “learning” of one or more events, operations, or processes. Thus, the cognitive model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term “cognitive” may refer to a cognitive system. The cognitive system may be a specialized computer system, or set of computer systems, configured with hardware and/or software logic (in combination with hardware logic upon which the software executes) to emulate human cognitive functions. These cognitive systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A cognitive system may perform one or more computer-implemented cognitive operations that approximate a human thought process while enabling a user or a computing system to interact in a more natural manner. A cognitive system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such cognitive systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

Additional aspects of the present invention and attendant benefits will be further described, following.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security parameters, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

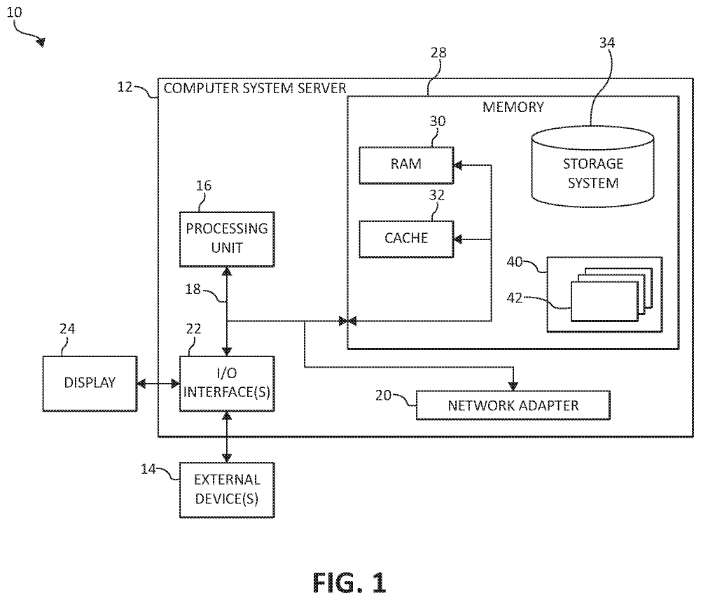

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

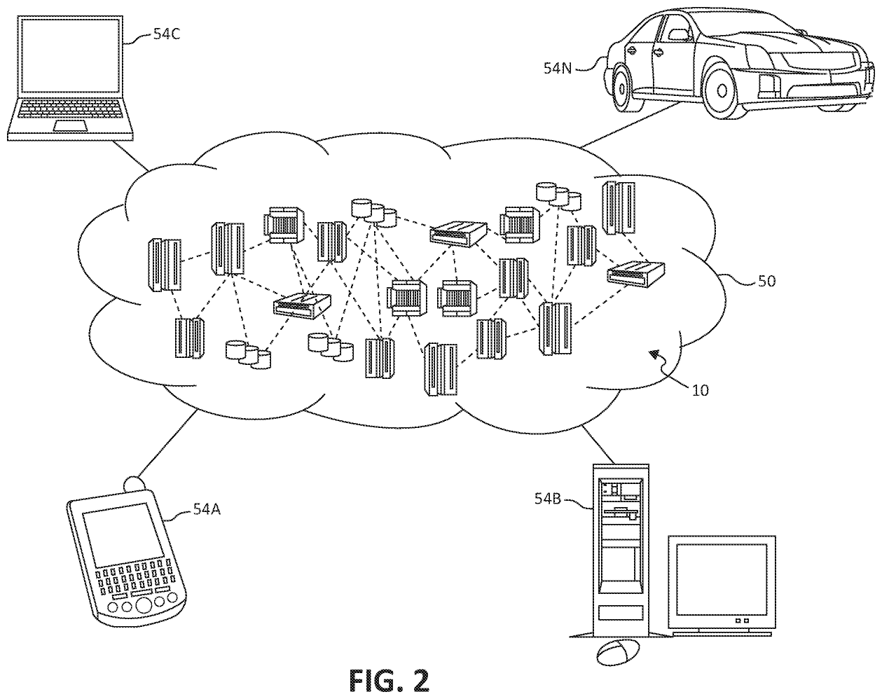

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

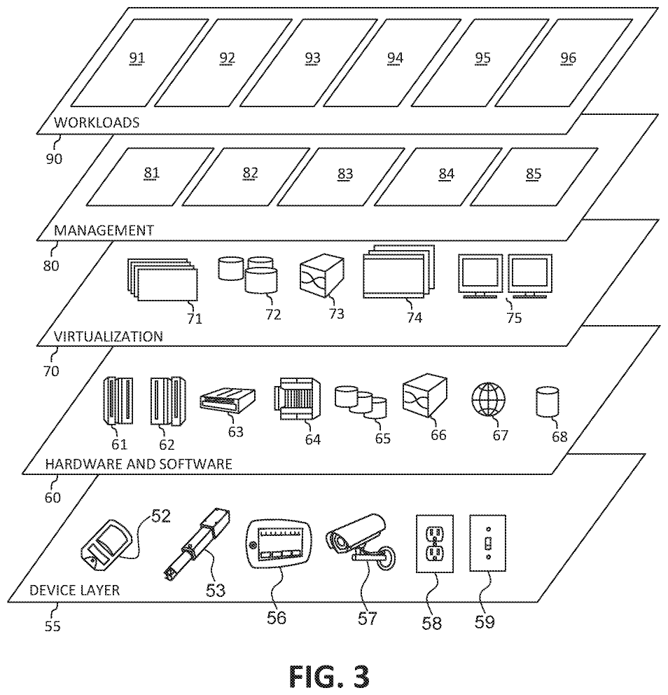

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various electronic billboard reuse workloads and functions 96. One of ordinary skill in the art will appreciate that the electronic billboard reuse workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

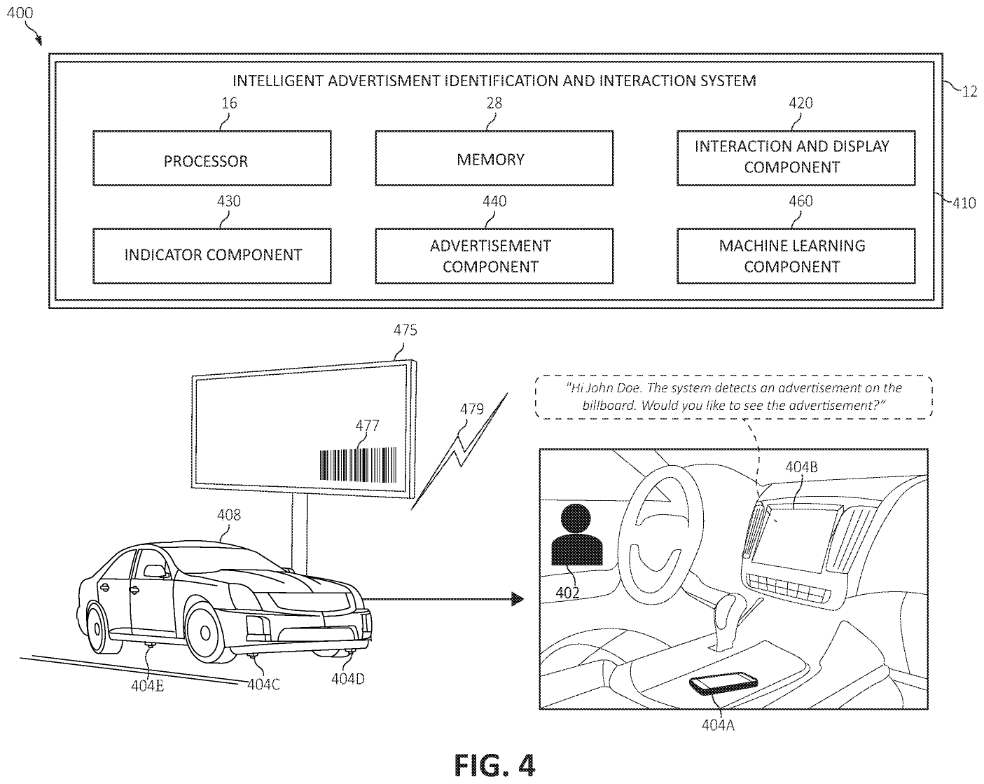

Turning to FIG. 4, a block diagram of various hardware 400 equipped with various functionality as will be further described is shown in which aspects of the mechanisms of the illustrated embodiments may be realized. In one aspect, one or more of the components, modules, services, applications, and/or functions described in FIGS. 1-3 may be used in FIG. 4.

For example, computer system/server 12 of FIG. 1 may be included in FIG. 4 and may be connected to other computing nodes (such as computer systems of vehicles) over a distributed computing network, where additional data collection, processing, analytics, and other functionality may be realized. The computer system/server 12 of FIG. 1, may include an intelligent advertisement identification and interaction system 410. In one embodiment, the intelligent advertisement identification and interaction system 410 may be in communication via network or communication link 479 with one or more vehicles such as, for example, vehicle 408.

In one aspect, the intelligent advertisement identification and interaction system 410 may be an independent computing service provided by one or more computing systems and servers (e.g., a centralized server “HUB”) for illustrative convenience but may be included in one or more components, modules, services, applications, and/or functions of FIGS. 1-3) and external to and/or internal to the vehicles 408. In an additional embodiment, the intelligent advertisement identification and interaction system 410 may be located and installed within one or more vehicles such as, for example, vehicle 408. Vehicle 408 may be associated with the intelligent advertisement identification and interaction system 410 via one or more pre-authorization operations and/or may be instantaneously joined to the intelligent advertisement identification and interaction system 410 via a series of authentication operations to join and grant permission to the intelligent advertisement identification and interaction system 410 to gain access to one or more IoT devices and/or computing systems of vehicles 408 for sharing the collaborative data.

Vehicle 408 may be driven by an occupant and/or by using self-driving technology (e.g., autopilot). Vehicle 408 may have installed thereon one or more internet of things (IoT) devices 404A-E, such as computing devices/sensor devices to gather data in relation to each of the occupants of the vehicle 408. That is, a variety of IoT devices 404A-E, such as cameras, sensor devices, audio input devices, recording devices, and/or sensor may be external to the vehicle 408 (e.g., a smartphone of a user synchronized with the computing system of the vehicle 408) and/or internal to the vehicle 408 (e.g., installed in and/or around the vehicle 408). In an additional aspect, the IoT devices 404A-E may be used collectively and/or individually to record, scan, captures, and/or photograph one or more advertisement displays such as, for example, an advertisement display 475 (e.g., a billboard having an indicator 477 such as, for example, a barcode that may be displayed on the billboard).

Vehicle 408 may also send/or received data from one or more external sources and/or IoT devices such as, for example, a user equipment (“UE”) 404A and/or a centralized computing console 404B (e.g., cellular telephone 54A, desktop computer 54B, laptop computer 54C, and/or automobile computer system 54N of FIG. 2 or other IoT devices such as a smart watch). For example, UE 404A may be a smart watch and centralized computing console 404B may be the automobile computer system 54N that may include an interactive graphical user interface (“GUI”).

Also, the intelligent advertisement identification and interaction system 410 may incorporate processing unit 16 (“processor”) and memory 28 of FIG. 1, for example, to perform various computational, data processing and other functionality in accordance with various aspects of the present invention. The intelligent advertisement identification and interaction system 410 may also include an interaction and display component 420, an indicator component 430, an advertisement component 440, and/or a machine learning component, each of which may be controlled and in communication with processing unit 16 and memory 28.

The indicator component 430 may send a signal and/or trigger one or more of the IoT devices 404A-E to capture one or more indicators 477 (e.g., QR code) associated on the advertisement display 475 using one or more IoT computing devices (e.g., IoT devices 404A-E) associated with the vehicle 408. That is, the indicator component 430 may send a signal and/or trigger one or more of the IoT devices 404A-E to scan and capture, using one or more IoT devices 404A-E (e.g., cameras) located on the vehicle 408, one or more indicators 477 associated on an advertisement display 475 while the one or more indicators 477 are displayed on the advertisement display 475. The one or more indicators 477 may be a QR code, barcode, one or more patterns, a scannable indicator, a selected image, or a combination thereof. The advertisement display 475 may be an advertisement display device, a computer display, an electronic billboard, an advertisement poster, traffic sign, or a combination thereof.

Using the data (e.g., photographs/video) that may be collected and/or received from the one or more IoT computing devices (e.g., IoT devices 404A-E), the indicator component 430 may identify the one or more indicators associated with the advertisement display, and/or determine a type of advertisement associated with the one or more indicators.

The advertisement component 440 may receive an advertisement associated with the one or more indicators 477 (e.g., barcode) upon capturing the one or more indicators. The advertisement component 440 may also send or receive one or more analytics associated with the advertisement.

The interaction and display component 420 may display the advertisement associated with the one or more indicators in a graphic user interface (“GUI”) of the vehicle, and/or display additional information associated with the advertisement in the GUI of the vehicle. The interaction and display component 420 may automatically accept a prompt to interact with the advertisement according to a type of entity responsible for creating the advertisement such as, for example, “Hi John Doe. The system detects an advertisement on the billboard. Would you like to see the advertisement?” The interaction and display component 420 may prompt a user such as, for example, user 402 to interact with an advertisement associated with the one or more indicators 477.

Thus, in one aspect, the interaction and display component 420 may temporarily interrupt currently displayed content on the one or more IoT computing devices such as, for example, UE 404A and/or the centralized computing console 404B associated with the vehicle 408 by prompting the user 402 to accept or reject the advertisement. In one aspect, if the advertisement is generated, created, and/or produced by a governmental agency, the advertisement/media may be automatically displayed on the one or more IoT computing devices such as, for example, UE 404A and/or the centralized computing console 404B.

The interaction and display component 420 may display on the one or more IoT computing devices such as, for example, UE 404A and/or the centralized computing console 404B the advertisement, analytics associated with the advertisement, or a combination thereof upon acceptance of the advertisement.

The machine learning component 460 may learn the one or more contextual factors, the user profiles, reinforced feedback learning, the user experience satisfaction level, or a combination thereof. For example, the machine learning component 460 may learn one or more types of media/advertisements that the user has accepted (e.g., preferred advertisements) and/or rejected (e.g., non-preferred advertisements) over a selected period of time. Thus, the machine learning component 460 may automatically accept and/or reject one or more learned types of media/advertisements that the user has previously accepted or rejected.

In one aspect, the machine learning component 460, as described herein, may be performed by a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

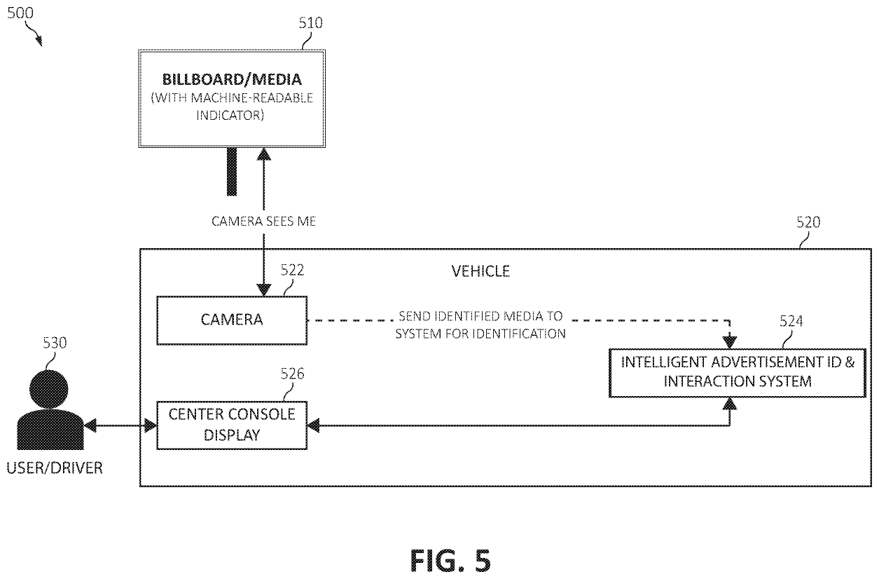

Turning now to FIG. 5, a block diagram of exemplary functionality 500 relating to intelligent advertisement identification and interaction in an IoT computing environment is depicted, for use in the overall context of intelligent advertisement identification and interaction according to various aspects of the present invention. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for intelligent advertisement identification and interaction in accordance with the present invention. Many of the functional blocks 500 may execute as background processes on various components, either in distributed computing components, or on the user device, or elsewhere, and generally unaware to the user performing generalized tasks.

An IoT computing device 522 (e.g., a camera) associated with a vehicle 520 may scan, observe, and/or identify an advertisement display on a billboard/media display 510 that may include media with a machine-readable indicator (e.g., QR code). The identified media and/or machine-readable indicator may be sent to an intelligent advertisement identification and interaction system 524 (see also the intelligent advertisement identification and interaction system 410 of FIG. 4). The intelligent advertisement identification (“ID”) and interaction system 524 may process, analyze, and/or display the identified media and/or machine-readable indicator via a computing system 526 of the vehicle 520 (e.g., a center console display device). The computing system 526 of the vehicle 520 may display and prompt the user 530 to accept or reject the displayed identified media and/or machine-readable indicator. If the user 530 accepts the identified media and/or machine-readable indicator, the computing system 526 may display the advertisement and/or additional information associated with the advertisement (e.g., analytical data). If the user 530 rejects the identified media and/or machine-readable indicator, the computing system 526 may terminate displaying the identified media and/or machine-readable indicator.

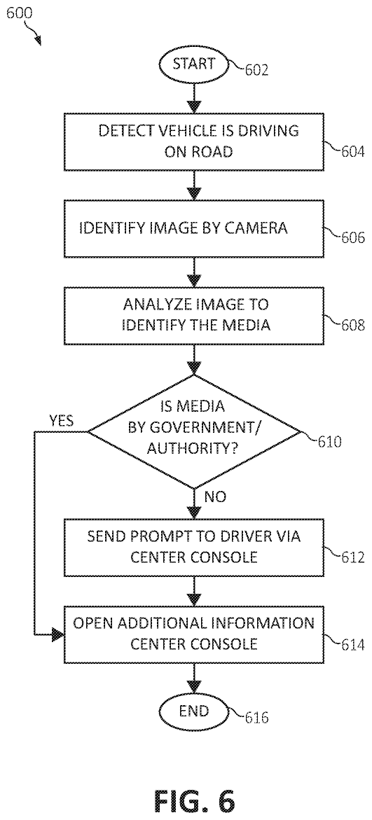

FIG. 6 is a flowchart diagram of an additional exemplary method for implementing intelligent advertisement identification and interaction in an Internet of Things (“IoT”) computing environment by a processor. The functionality 600 may be implemented as a method executed as instructions on a machine, where the instructions are included on at least one computer readable medium or on a non-transitory machine-readable storage medium. The functionality 6700 may start in block 602.

A vehicle may be detected as being in motion (e.g., the vehicle is driving/moving on a road), as in block 604. An IoT computing device (e.g., a camera) associated with the vehicle may scan, observe, and/or identify an advertisement display (e.g., a billboard), as in block 606. One or more images (e.g., an indicator) associated with the advertisement display may be analyzed to identify media/advertisement, as in block 608. An operation may be performed to determine if the media/advertisement is created/produced/owned by a governmental agency, as in block 610. If no, the vehicle (e.g., a driver of the vehicle) may be prompted via an GUI of the vehicle (e.g., a center console computing system and/or IoT device associated with both the driver and/or the vehicle such as, for example, a smart phone and/or smart watch), as in block 612. If yes from block 610 and also from block 612, additional information (e.g., analytics) may be received and/or displayed on the GUI of the vehicle (and/or the IoT device associated with both the driver and/or the vehicle), as in block 614. The functionality 600 may end in block 616.

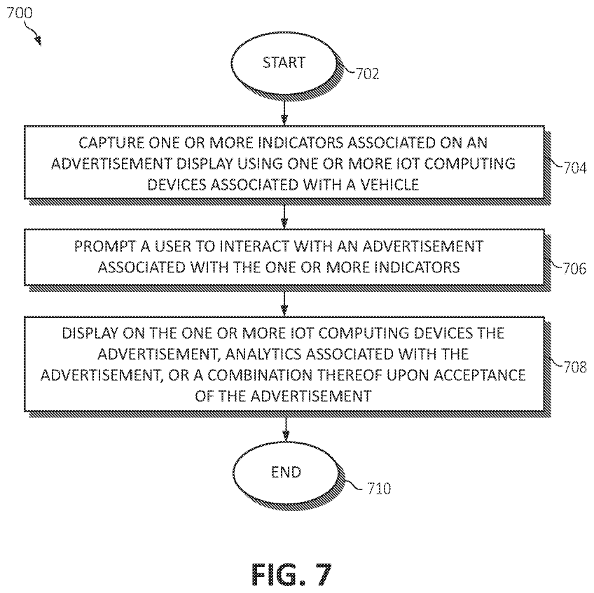

FIG. 7 is a flowchart diagram of an additional exemplary method for implementing intelligent advertisement identification and interaction in an IoT computing environment by a processor. The functionality 700 may be implemented as a method executed as instructions on a machine, where the instructions are included on at least one computer readable medium or on a non-transitory machine-readable storage medium. The functionality 700 may start in block 702.

One or more indicators associated on an advertisement display may be captured using one or more IoT computing devices associated with a vehicle, as in block 704. A user may be prompted to interact with an advertisement associated with the one or more indicators, as in block 706. The advertisement, analytics associated with the advertisement, or a combination thereof may be displayed on the one or more IoT computing devices upon acceptance of the advertisement, as in block 708. The functionality 700 may end in block 710.

In one aspect, in conjunction with and/or as part of at least one block of FIG. 7, the operations of 700 may include each of the following. The operations of 700 may define the one or more indicators as a quick response (QR) code, barcode, one or more patterns, a scannable indicator, a selected image, or a combination thereof, and/or define the advertisement display as an advertisement display device, an electronic billboard, an advertisement poster, traffic sign, or a combination thereof.

The operations of 700 may identify the one or more indicators associated with the advertisement display, and/or determine a type of advertisement associated with the one or more indicators. The operations of 700 may receive the advertisement associated with the one or more indicators upon capturing one or more indicators, and/or send or receive one or more analytics associated with the advertisement. The operations of 700 may display the advertisement associated with the one or more indicators in a graphic user interface (“GUI”) of the vehicle, and/or display additional information associated with the advertisement in the GUI of the vehicle. The operations of 700 may automatically accept a prompt to interact with the advertisement according to a type of entity responsible for creating the advertisement. Also, the operations of 700 may scan and capture, using one or more cameras located on the vehicle, one or more indicators associated on an advertisement display while the one or more indicators are displayed on the advertisement display, temporarily interrupt currently displayed content on the one or more IoT computing devices associated with the vehicle by prompting the user to accept or reject the advertisement, and display, on the one or more IoT computing devices, the advertisement, analytics associated with the advertisement, or a combination thereof upon acceptance of the advertisement.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for implementing intelligent advertisement identification and interaction in an Internet of Things (“IoT”) computing environment, comprising:
capturing one or more indicators associated on an advertisement display using one or more IoT computing devices associated with a vehicle; and
prompting a user to interact with an advertisement associated with the one or more indicators.

2. The method of claim 1, further including:
defining the one or more indicators as a quick response (QR) code, barcode, one or more patterns, a scannable indicator, a selected image, or a combination thereof; and
defining the advertisement display as an advertisement display device, an electronic billboard, an advertisement poster, traffic sign, or a combination thereof.

3. The method of claim 1, further including:
identifying the one or more indicators associated with the advertisement display; and
determining a type of advertisement associated with the one or more indicators.

4. The method of claim 1, further including:
receiving the advertisement associated with the one or more indicators upon capturing one or more indicators; or
sending or receiving one or more analytics associated with the advertisement.

5. The method of claim 1, further including:
displaying the advertisement associated with the one or more indicators in a graphic user interface (“GUI”) of the vehicle; or
displaying additional information associated with the advertisement in the GUI of the vehicle.

6. The method of claim 1, further including automatically accepting a prompt to interact with the advertisement according to a type of entity responsible for creating the advertisement.

7. The method of claim 1, further including:
scanning and capturing, using one or more cameras located on the vehicle, one or more indicators associated with the advertisement display while the one or more indicators are displayed on the advertisement display;
temporarily interrupting currently displayed content on the one or more IoT computing devices associated with the vehicle by prompting the user to accept or reject the advertisement; and
displaying, on the one or more IoT computing devices, the advertisement, analytics associated with the advertisement, or a combination thereof upon acceptance of the advertisement.

8. A system for implementing intelligent advertisement identification and interaction in an Internet of Things (“IoT”) computing environment, comprising:
one or more computers with executable instructions that when executed cause the system to:
capture one or more indicators associated on an advertisement display using one or more IoT computing devices associated with a vehicle; and
prompt a user to interact with an advertisement associated with the one or more indicators.

9. The system of claim 8, wherein the executable instructions further:
define the one or more indicators as a quick response (QR) code, barcode, one or more patterns, a scannable indicator, a selected image, or a combination thereof; and
define the advertisement display as an advertisement display device, an electronic billboard, an advertisement poster, traffic sign, or a combination thereof.

10. The system of claim 8, wherein the executable instructions further:
identify the one or more indicators associated with the advertisement display; and
determine a type of advertisement associated with the one or more indicators.

11. The system of claim 8, wherein the executable instructions further:
receive the advertisement associated with the one or more indicators upon capturing one or more indicators; or
send or receive one or more analytics associated with the advertisement.

12. The system of claim 8, wherein the executable instructions further:
display the advertisement associated with the one or more indicators in a graphic user interface (“GUI”) of the vehicle; or
display additional information associated with the advertisement in the GUI of the vehicle.

13. The system of claim 8, wherein the executable instructions further automatically accept a prompt to interact with the advertisement according to a type of entity responsible for creating the advertisement.

14. The system of claim 8, wherein the executable instructions further:
scan and capture, using one or more cameras located on the vehicle, one or more indicators associated with the advertisement display while the one or more indicators are displayed on the advertisement display;
temporarily interrupt currently displayed content on the one or more IoT computing devices associated with the vehicle by prompting the user to accept or reject the advertisement; and
display, on the one or more IoT computing devices, the advertisement, analytics associated with the advertisement, or a combination thereof upon acceptance of the advertisement.

15. A computer program product for implementing intelligent advertisement identification and interaction in an Internet of Things (“IoT”) computing environment by a processor, the computer program product comprising a non-transitory computer-readable storage medium having computer-readable program code portions stored therein, the computer-readable program code portions comprising:
an executable portion that captures one or more indicators associated on an advertisement display using one or more IoT computing devices associated with a vehicle; and
an executable portion that prompts a user to interact with an advertisement associated with the one or more indicators.

16. The computer program product of claim 15, further including an executable portion that:
defines the one or more indicators as a quick response (QR) code, barcode, one or more patterns, a scannable indicator, a selected image, or a combination thereof; and
defines the advertisement display as an advertisement display device, an electronic billboard, an advertisement poster, traffic sign, or a combination thereof.

17. The computer program product of claim 15, further including an executable portion that:
identifies the one or more indicators associated with the advertisement display; and
determines a type of advertisement associated with the one or more indicators.

18. The computer program product of claim 15, further including an executable portion that:
receives the advertisement associated with the one or more indicators upon capturing one or more indicators;
automatically accepts a prompt to interact with the advertisement according to a type of entity responsible for creating the advertisement; or
sends or receives one or more analytics associated with the advertisement.

19. The computer program product of claim 15, further including an executable portion that:
display the advertisement associated with the one or more indicators in a graphic user interface (“GUI”) of the vehicle; or
display additional information associated with the advertisement in the GUI of the vehicle.

20. The computer program product of claim 15, further including an executable portion that:
scans and captures, using one or more cameras located on the vehicle, one or more indicators associated with the advertisement display while the one or more indicators are displayed on the advertisement display;
temporarily interrupts currently displayed content on the one or more IoT computing devices associated with the vehicle by prompting the user to accept or reject the advertisement; and
displays, on the one or more IoT computing devices, the advertisement, analytics associated with the advertisement, or a combination thereof upon acceptance of the advertisement.
